(19) United States
(12) Patent Application Publication
(10) Pub. No.: US 2025/0318003 A1
(43) Pub. Date: Oct. 9, 2025

(54) ECN MARKING FOR XR IN DC

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US); Hyun Yong LEE, San Diego, CA (US)

(21) Appl. No.: 19/053,340

(22) Filed: Feb. 13, 2025

Related U.S. Application Data
(60) Provisional application No. 63/575,502, filed on Apr. 5, 2024.

(51) Int. Cl. H04W 76/15; H04L 5/00; H04W 28/02

(52) U.S. Cl. CPC H04W 76/15; H04L 5/0053; H04W 28/0268; H04W 28/0284

(57) ABSTRACT

A method for wireless communication at a first network node and related apparatus are provided. In the method, the first network node communicates with a user equipment (UE) based on dual connectivity with a second network node. The first network node further receives a configuration for explicit congestion notification (ECN) marking at one or more of a quality of service (QoS) flow level or a data radio bearer (DRB) level; and provides, to the second network node, ECN marking information. The ECN marking information is based on the configuration.

### CROSS REFERENCE TO RELATED APPLICATION(S)

This application claims the benefit of and priority to U.S. Provisional Application Ser. No. 63/575,502, entitled “ECN MARKING FOR XR IN DC” and filed on Apr. 5, 2024, which is expressly incorporated by reference herein in its entirety.

### TECHNICAL FIELD

The present disclosure relates generally to communication systems and, more particularly, to the explicit congestion notification (ECN) marking in dual connectivity.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a first network node. The apparatus may include at least one memory and at least one processor coupled to the at least one memory. Based at least in part on information stored in the at least one memory, the at least one processor may be configured to communicate with a user equipment (UE) based on dual connectivity with a second network node; receive a configuration for explicit congestion notification (ECN) marking at one or more of a quality of service (QoS) flow level or a data radio bearer (DRB) level; and provide, to the second network node, ECN marking information, wherein the ECN marking information is based on the configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A is a diagram illustrating an example of an ECN marking or congestion information reporting request information element (IE).

FIG. 4B is a diagram illustrating an example of an ECN marking or congestion information reporting status IE.

FIG. 5 is a diagram illustrating an example of network side protocols in new radio dual connectivity (NR-DC).

FIG. 6A is a diagram illustrating an example S-NODE ADDITION REQUEST message including the ECN marking or congestion information reporting request IE.

FIG. 6B is a diagram illustrating an example S-NODE MODIFICATION REQUEST message including the ECN marking or congestion information reporting request IE.

FIG. 7 is a diagram illustrating an example of an ECN marking or congestion information reporting status IE.

FIG. 8A is a diagram illustrating an example S-NODE ADDITION REQUEST ACKNOWLEDGE message including the ECN marking or congestion information reporting status IE.

FIG. 8B is a diagram illustrating an example S-NODE MODIFICATION REQUEST ACKNOWLEDGE message including the ECN marking or congestion information reporting status IE.

FIG. 9 is a diagram illustrating various entities corresponding to the changes to be implemented for various bearers in accordance with various aspects of the present disclosure.

FIG. 10A is a diagram illustrating an example S-NODE ADDITION REQUEST message including the DRB ECN marking or congestion information reporting request IE.

FIG. 10B is a diagram illustrating an example S-NODE MODIFICATION REQUEST message including the DRB ECN marking or congestion information reporting request IE.

FIG. 11 is a diagram illustrating the network entities involved in the DRBs configuration in accordance with various aspects of the present disclosure.

FIG. 12 is a diagram illustrating an example DRB ECN marking or congestion information reporting request IE in accordance with various aspects of the present disclosure.

FIG. 13 is a diagram illustrating an example DRB ECN marking or congestion information reporting status IE in accordance with various aspects of the present disclosure.

FIG. 14A is a diagram illustrating an example S-NODE ADDITION REQUEST ACKNOWLEDGE message including the DRB ECN marking or congestion information reporting status IE.

FIG. 14B is a diagram illustrating an example S-NODE MODIFICATION REQUEST ACKNOWLEDGE message including the DRB ECN marking or congestion information reporting status IE.

FIG. 15 is a diagram illustrating an example S-NODE MODIFICATION REQUIRED message including the DRB ECN marking or congestion information reporting request IE.

FIG. 16 is a diagram illustrating the network entities involved in the DRBs configuration in accordance with various aspects of the present disclosure.

FIG. 17 is a diagram illustrating an example S-NODE MODIFICATION CONFIRM message including the DRB ECN marking or congestion information reporting status IE.

FIG. 18 is a diagram illustrating an example of the transfer of assistance information data.

FIG. 19 is a diagram illustrating examples of DL congestion information and UL congestion information IEs of the ASSISTANCE INFORMATION DATA frame.

FIG. 20 is a call flow diagram illustrating a method of wireless communication in accordance with various aspects of the present disclosure.

FIG. 21 is a flowchart illustrating methods of wireless communication at a first network node in accordance with various aspects of the present disclosure.

FIG. 22 is a flowchart illustrating methods of wireless communication at a first network node in accordance with various aspects of the present disclosure.

FIG. 23 is a diagram illustrating an example of a hardware implementation for an example apparatus and/or UE.

FIG. 24 is a diagram illustrating an example of a hardware implementation for an example network entity.

### DETAILED DESCRIPTION

In wireless communication, a network node may detect the congestion and perform explicit congestion notification (ECN) marking for uplink or downlink communication. However, in dual connectivity (DC), where user equipment (UE) simultaneously communicates with multiple network nodes, ECN marking support is insufficient. For example, there is a lack of ECN marking support for secondary cell group (SCG) bearers that are terminated at the secondary node (SN), master node (MN) terminated SCG bearers, SN-terminated master cell group (MCG) bearers, and split bearers. Additionally, the current user plane protocol does not support the reporting of congestion information for the protocol data unit (PDU) set. Example aspects presented herein provide methods and apparatus to support the ECN marking in DC.

Various aspects relate generally to wireless communication. Some aspects more specifically relate to the ECN marking in dual connectivity. In some examples, a first network node may communicate with a user equipment (UE) based on dual connectivity with a second network node. The first network node may further receive a configuration for ECN marking at one or more of a quality of service (QoS) flow level or a data radio bearer (DRB) level; and provide, to the second network node, ECN marking information. The ECN marking information may be based on the configuration.

Particular aspects of the subject matter described in this disclosure can be implemented to realize one or more of the following potential advantages. In some examples, by enabling the ECN marking in network nodes used in DC communication, the described techniques can be used to provide congestion information to the network nodes in DC at a QoS level or a DRB level, thereby enabling more efficient management of wireless communication according to the network conditions.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an clement, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

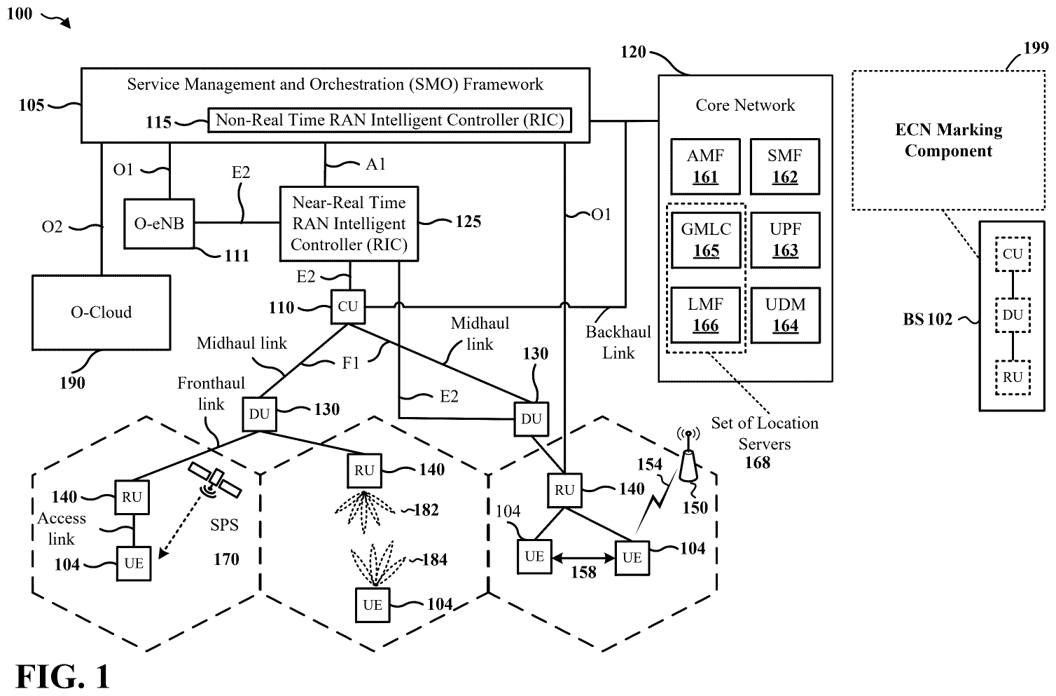

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-FiTM (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, a network node such as the base station 102 may include an ECN marking component 199. The ECN marking component 199 may be configured to communicate with a UE based on dual connectivity with a second network node; receive a configuration for ECN marking at one or more of a QoS flow level or a DRB level; and provide, to the second network node, ECN marking information. The ECN marking information may be based on the configuration. Although the following description may be focused on 5G NR, the concepts described herein may be applicable to other similar areas, such as LTE, LTE-A, CDMA, GSM, and other wireless technologies.

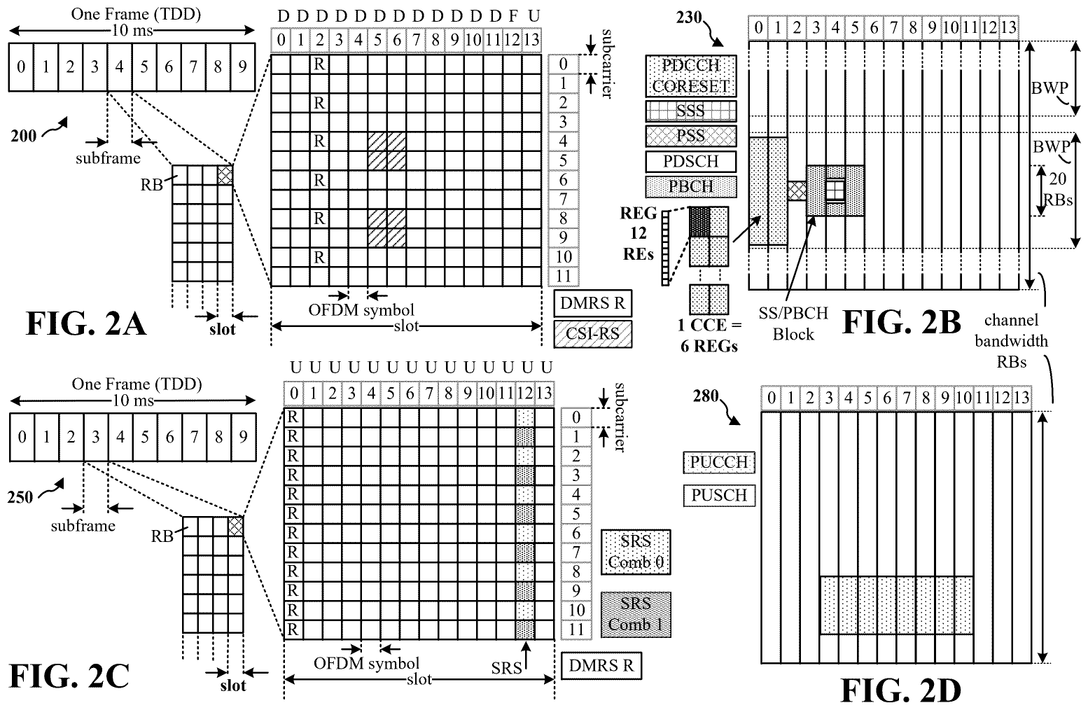

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1(with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δƒ = 2^{μ} · 15 [KHz] | Cyclic prefix |
|---|---|---|
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (sec FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

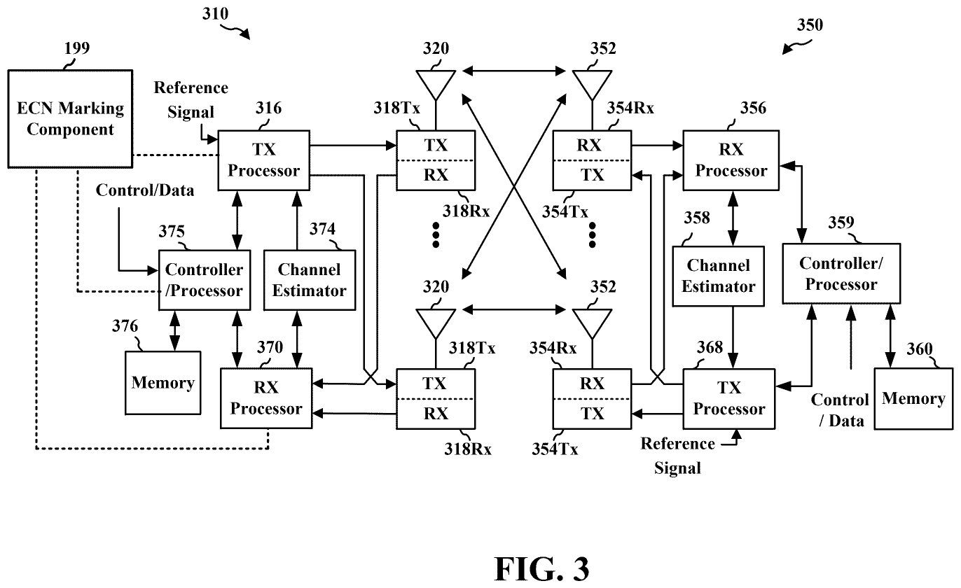

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the ECN marking component 199 of FIG. 1.

Example aspects presented herein provide methods and apparatus for the ECN marking in dual connectivity (DC). For example, when configured for dual connectivity, a UE may be served by a first network node as a primary node (MN) (which may be referred to as a master node in some aspects) and by a second network node as a secondary node (SN).

In wireless communication, a network node, such as a RAN (e.g., a next generation radio access network (NG-RAN)), base station, or one or more components of a base station, may be responsible for the detection of network congestion, and the RAN or the user plane function (e.g., UPF 163 in FIG. 1) may perform the ECN marking. In some examples, the RAN may detect the congestion and perform ECN marking for the uplink and downlink in the internet protocol (IP) layer of the received packets. Then, the RAN may send the packets to the UE for downlink or to the UPF for uplink. In some examples, the RAN may detect the congestion for the uplink or downlink flow and send the latest congestion information to the UPF. Based on the received congestion report, the UPF may perform ECN marking for the uplink and downlink IP layer of the received packets.

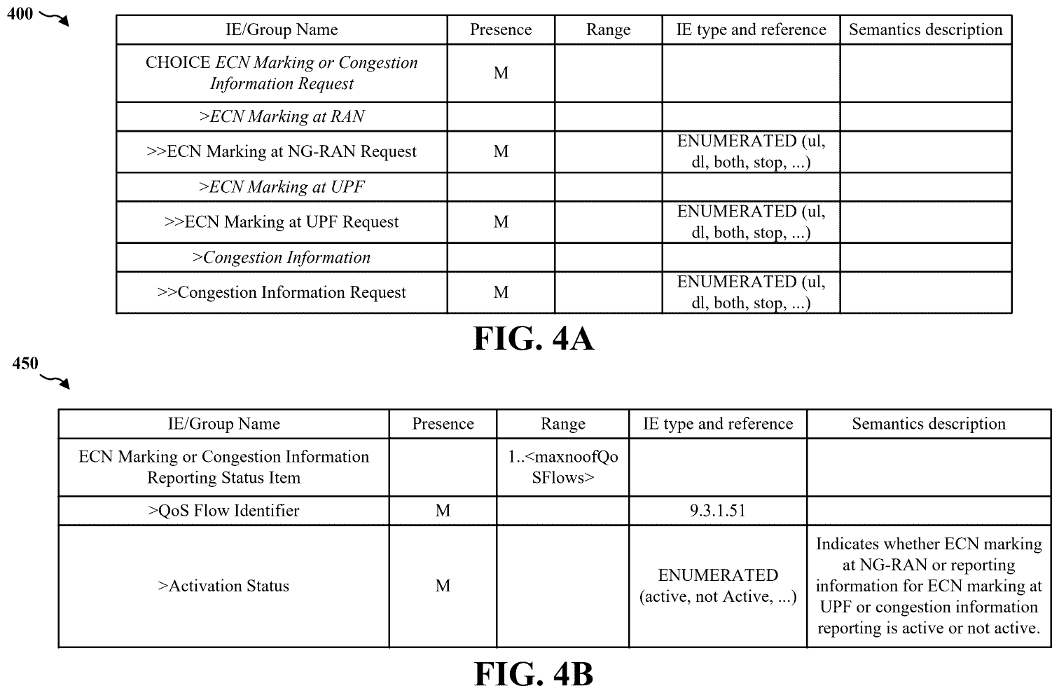

In some examples, the core network (CN), such as the core network 120 in FIG. 1, may configure the RAN to perform ECN marking or report congestion information via the next generation application protocol (NG-AP), via a request, which may be referred to as an “ECN Marking or congestion information reporting request” information element (IE) in, for example, a PDU Session Resource Setup Request. Subsequently, the NG-RAN may report the activation status information to the CN through an NG-AP ECN marking or congestion information reporting status IE, e.g., which may be referred to as “ECN marking or congestion information reporting status” in, for example, a PDU session resource setup response. FIG. 4A is a diagram illustrating an example of a request, which may be referred to as an “ECN marking or congestion information reporting request” IE. As shown in FIG. 4A, the IE 400 indicates to the NG-RAN node to perform ECN marking or to report information for ECN marking or to report congestion information for a quality or service (QOS) flow. FIG. 4B is a diagram illustrating an example of ECN marking or congestion information reporting status IE. As shown in FIG. 4B, the IE 450 contains a list of QoS flows with activation status information for NG-RAN node to perform ECN marking or to report information for ECN marking or to report congestion information reporting.

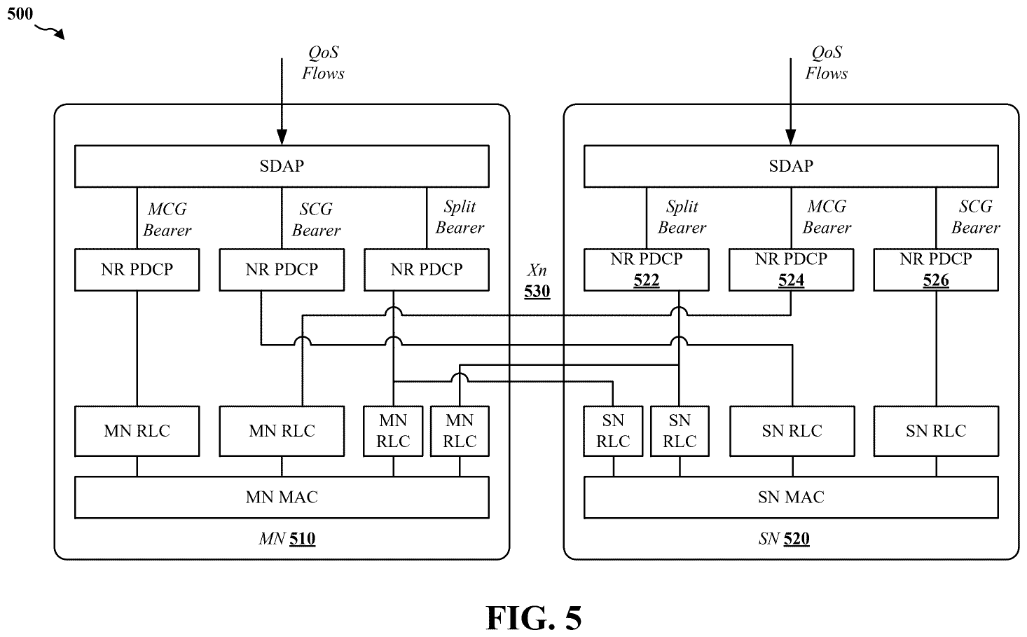

As an example of dual connectivity, FIG. 5 is a diagram 500 illustrating an example of network side protocols in new radio dual connectivity (NR-DC). In FIG. 5, the NR-DC may involve connections with a master node (MN) 510 and a secondary node (SN) 520. With the secondary node (e.g., SN 520) terminated bearers, the protocol data convergence protocol (PDCP) entity resides in the SN (e.g., SN 520), such as PDCP 522, 524, 526, and the SN (e.g., SN 520) may be in charge of the ECN marking.

In some examples, it would be beneficial to support extended reality (XR) applications in dual connectivity (e.g., NR-DC) scenarios. Example aspects presented herein provide methods and apparatus to support ECN marking in XR DC.

In DC scenarios in wireless communication, the aspects presented herein address three problems relating to support for the ECN marking. The first problem is the lack of ECN marking support for secondary cell group (SCG) bearers that are terminated at the SN. The second problem is the lack of ECN marking support for the SCG bearers that are terminated at the master node (MN) or primary node, the master cell group (MCG) bearers that are terminated at the SN, and the split bearers. The third problem is the lack of support for reporting congestion information for the protocol data unit (PDU) set.

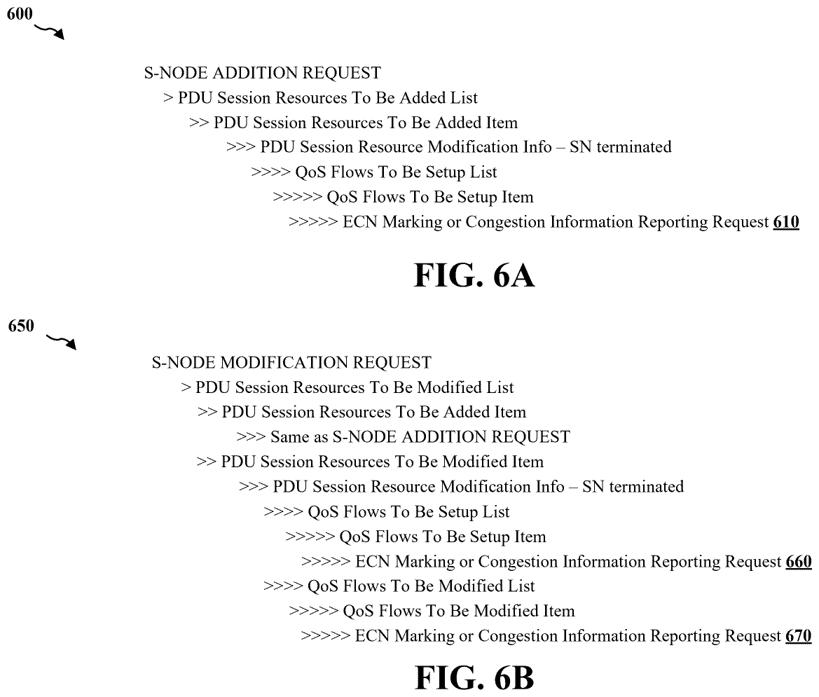

In some aspects, to enable SN configuration for ECN marking and congestion reporting, the Xn (e.g., Xn 530) IE ECN marking or congestion information reporting request” (e.g., IE 400) may be added to a DC specific message. In some aspects, the ECN marking or congestion information reporting request IE (e.g., IE 400) may be added to one or more of the S-node addition request message or the S-node modification request message. FIG. 6A is a diagram illustrating an example S-node addition request. As shown in FIG. 6A, a S-node addition request message 600 may include the ECN marking or congestion information reporting request IE 610. FIG. 6B is a diagram illustrating an example S-node modification request message. As shown in FIG. 6B, a S-node modification request message 650 may include one or more ECN marking or congestion information reporting request IEs, such as ECN marking or congestion information reporting request IE at 660, 670.

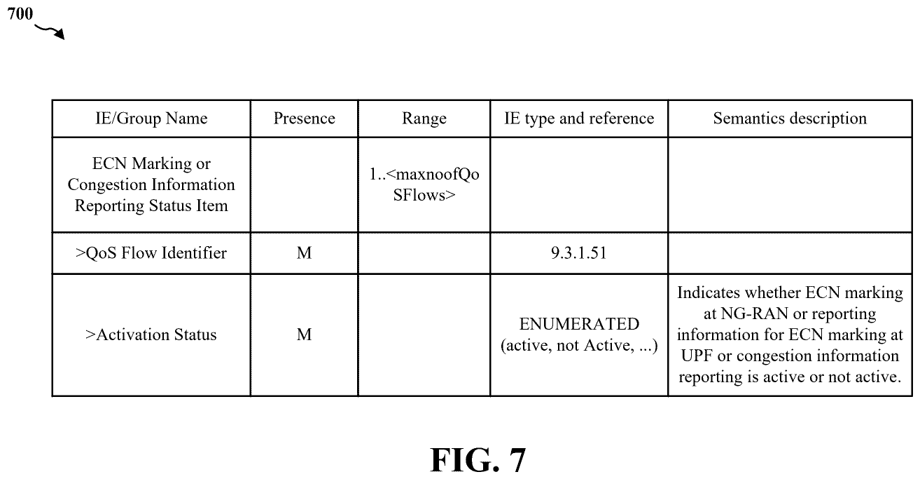

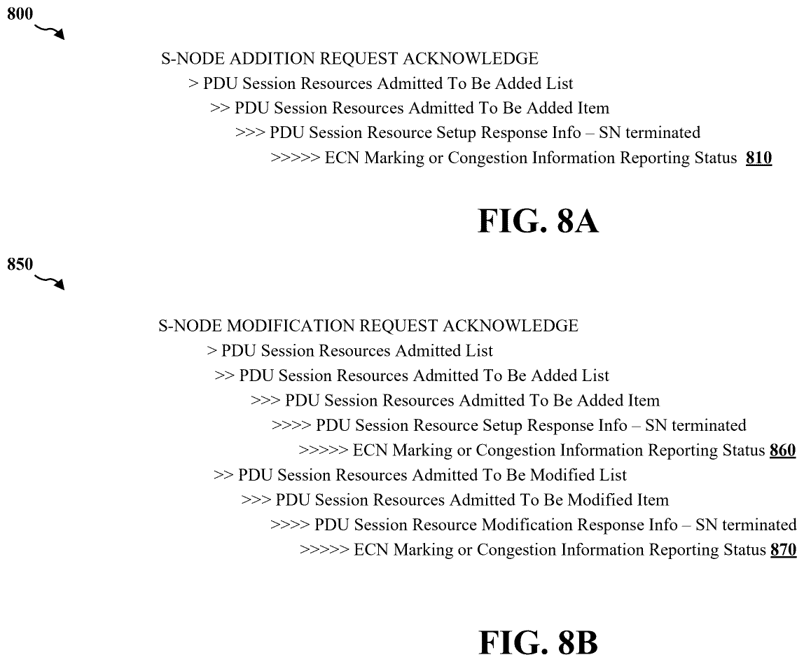

In some examples, a new Xn ECN marking or congestion information reporting status IE may be added to DC specific response messages. For example, a new ECN marking or congestion information reporting status IE may be added to one or more of the S-node addition acknowledge message or the S-node modification request acknowledge message. In some examples, the new Xn application protocol (Xn-AP) ECN marking or congestion information reporting status IE may be defined as in the NG-AP interface. FIG. 7 is a diagram illustrating an example of ECN marking or congestion information reporting status IE. As shown in FIG. 7, the IE 700 contains a list of QoS flows with activation status information for NG-RAN node to perform ECN marking or to report information for ECN marking, or to reporting congestion information reporting. FIG. 8A is a diagram illustrating an example S-NODE ADDITION REQUEST ACKNOWLEDGE message. As shown in FIG. 8A, a S-node addition request acknowledge message 800 may include the ECN marking or congestion information reporting status IE 810. FIG. 8B is a diagram illustrating an example S-node modification request acknowledge message. As shown in FIG. 8B, a S-node modification request acknowledge message 850 may include one or more the ECN marking or congestion information reporting status IEs, such as “ECN marking or congestion information reporting status” IE at 860, 870.

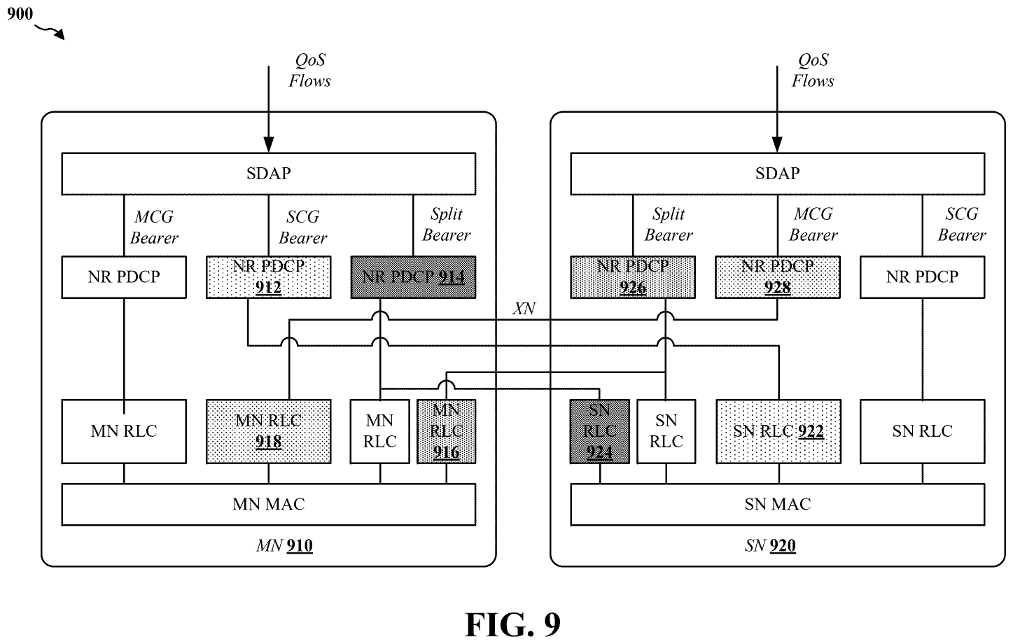

In some aspects, to enable ECN marking for MN terminated SCG bearers, SN terminated MCG bearers and Split bearers, the MN may configure DRBs in SN with ECN marking, the SN may configure DRBs in MN with ECN marking, and MN (or SN) may configure DRBs in SN (or MN) with ECN marking. Table 2 shows example aspects to be implemented for various bearers. FIG. 9 is a diagram 900 illustrating various entities corresponding to the changes to be implemented for various bearers in accordance with various aspects of the present disclosure. Referring to FIG. 9, the entities corresponding to the changes to be implemented for various bearers may include NR PDCP 912, NR PDCP 914, MN RLC 916, and MN RLC 918 in MN 910. The entities corresponding to the changes to be implemented for various bearers may further include SN RLC 922, SN RLC 924, NR PDCP 926, and NR PDCP 928 in SN 920.

TABLE 2
Changes to be implemented for various bearers

| Bearers | Changes |
|---|---|
| MN terminated | MN configures DRBs in SN with ECN marking |
| SCG bearers | |
| SN terminated | SN configures DRBs in MN with ECN marking |
| MCG bearers | |
| Split bearers | MN/SN configures DRBs in SN/MN with ECN |
| | marking |

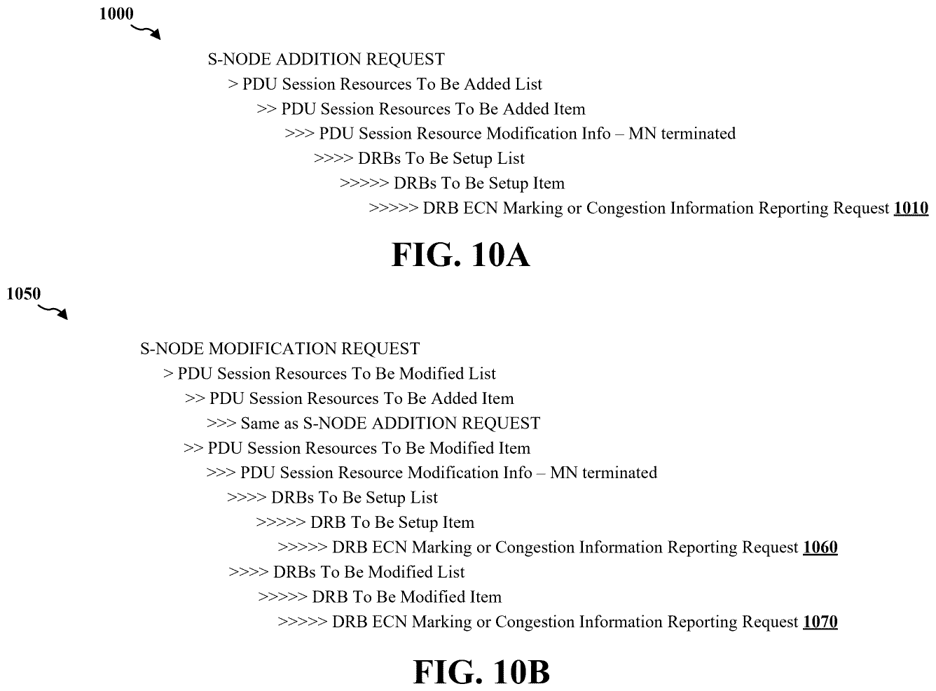

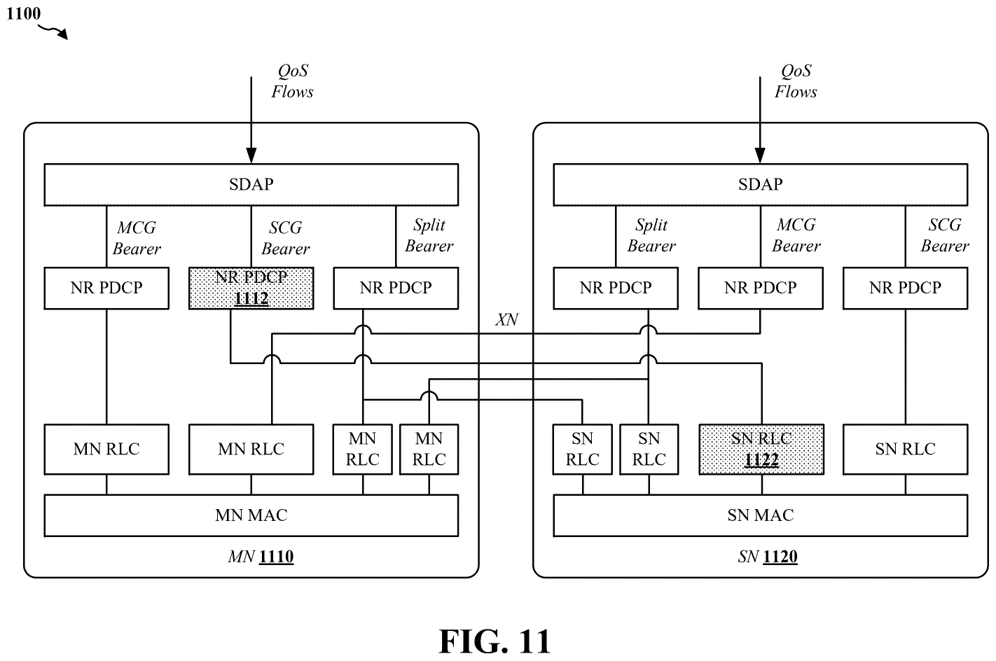

In some aspects, the MN may configure DRBs in SN with (e.g., for) ECN marking. For example, a new Xn-AP DRB ECN marking or congestion information reporting request IE, e.g., which may be referred to as DRB ECN marking or congestion information reporting request IE may be added to one or more of: the S-node addition request message or the S-node modification request message. FIG. 10A is a diagram illustrating an example S-node addition request message. As shown in FIG. 10A, a S-node addition request message 1000 may include the DRB ECN marking or congestion information reporting request IE 1010. FIG. 10B is a diagram illustrating an example S-node modification request message. As shown in FIG. 10B, a S-node modification request message 1050 may include the DRB ECN marking or congestion information reporting request IE at 1060, 1070. FIG. 11 is a diagram 1100 illustrating the network entities involved in the DRBs configuration in accordance with various aspects of the present disclosure. As shown in FIG. 11, the entities involved in the DRBs configuration (e.g., in FIG. 10A, FIG. 10B) may include the NR PDCP 1112 in the MN 1110 and the SN RLC 1122 in the SN 1120.

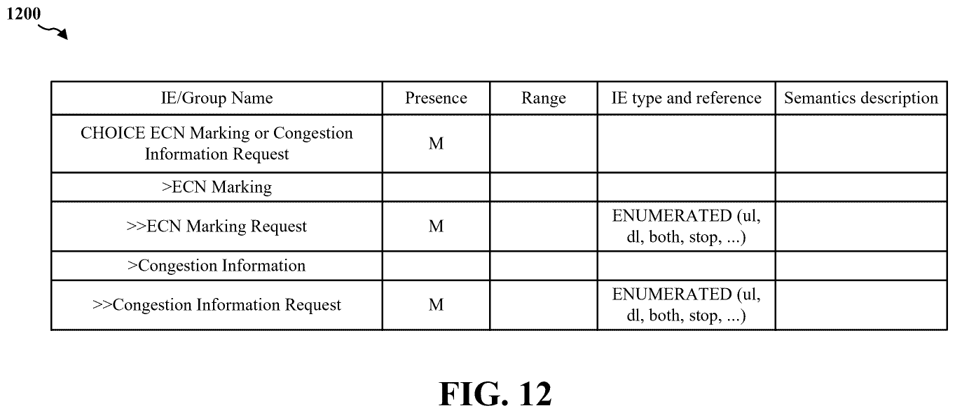

In some aspects, for the MN (e.g., MN 1110) to configure DRBs in SN (e.g., SN 1120) with ECN marking, the Xn-AP DRB ECN marking or congestion information reporting request IE may be similar to DRB ECN marking or congestion information reporting request as in the F1 interface. FIG. 12 is a diagram illustrating an example DRB ECN marking or congestion information reporting request IE 1200 in accordance with various aspects of the present disclosure.

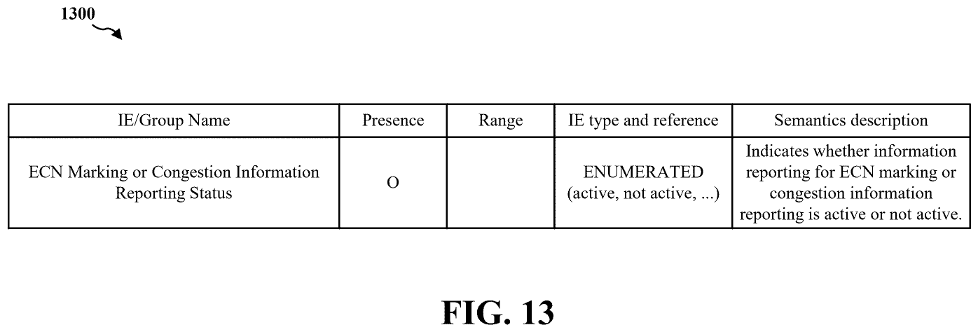

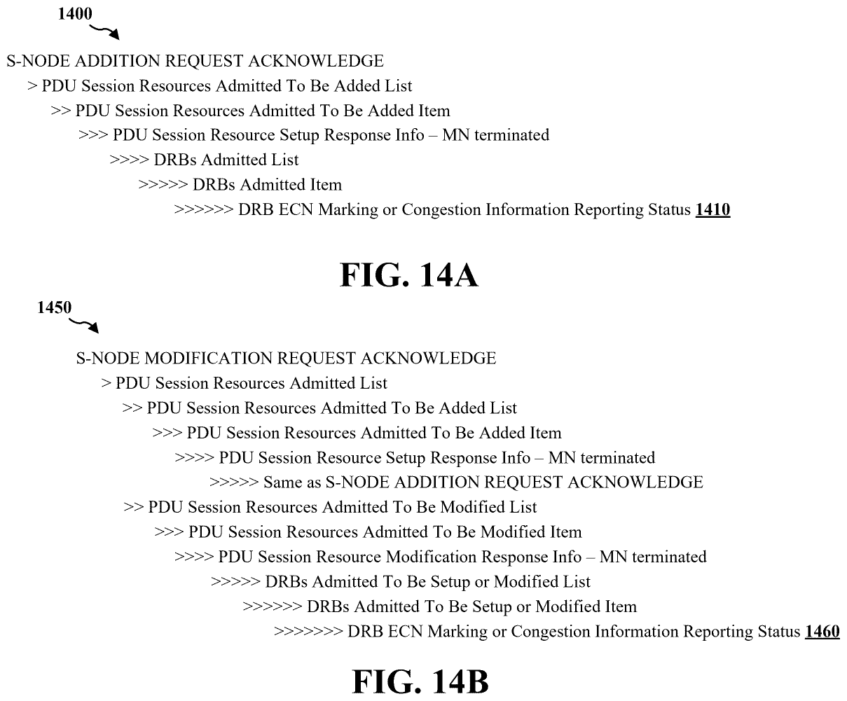

In some aspects, for the MN (e.g., MN 1110) to configure DRBs in the SN (e.g., SN 1120) with (e.g., for) ECN marking, a new Xn-AP DRB ECN marking or congestion information reporting status IE may be added to the Xn-AP messages. The Xn-AP messages may include one or more of the S-node addition request acknowledge message or the S-node modification request acknowledge message. In some examples, the new Xn-AP DRB ECN marking or congestion information reporting status IE may be specified as in the F1 interface. FIG. 13 is a diagram illustrating the DRB ECN marking or congestion information reporting status IE 1300 in accordance with various aspects of the present disclosure. FIG. 14A is a diagram illustrating an example S-node addition request acknowledge message. As shown in FIG. 14A, a S-node addition request acknowledge message 1400 may include the DRB ECN marking or congestion information reporting status IE 1410. FIG. 14B is a diagram illustrating an example S-node modification request acknowledge message. As shown in FIG. 14B, a S-node modification request acknowledge message 1450 may include the DRB ECN marking or congestion information reporting status IE 1460.

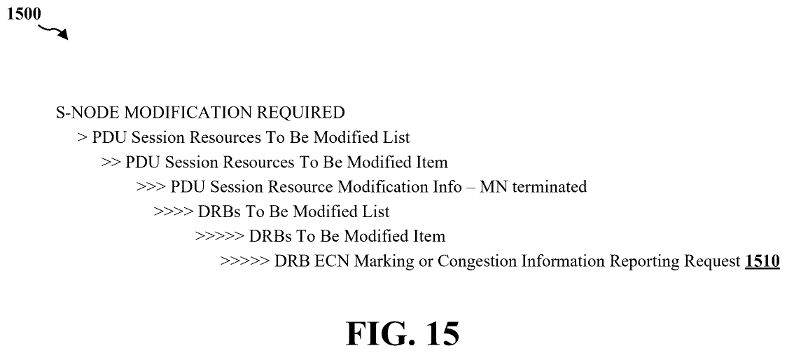

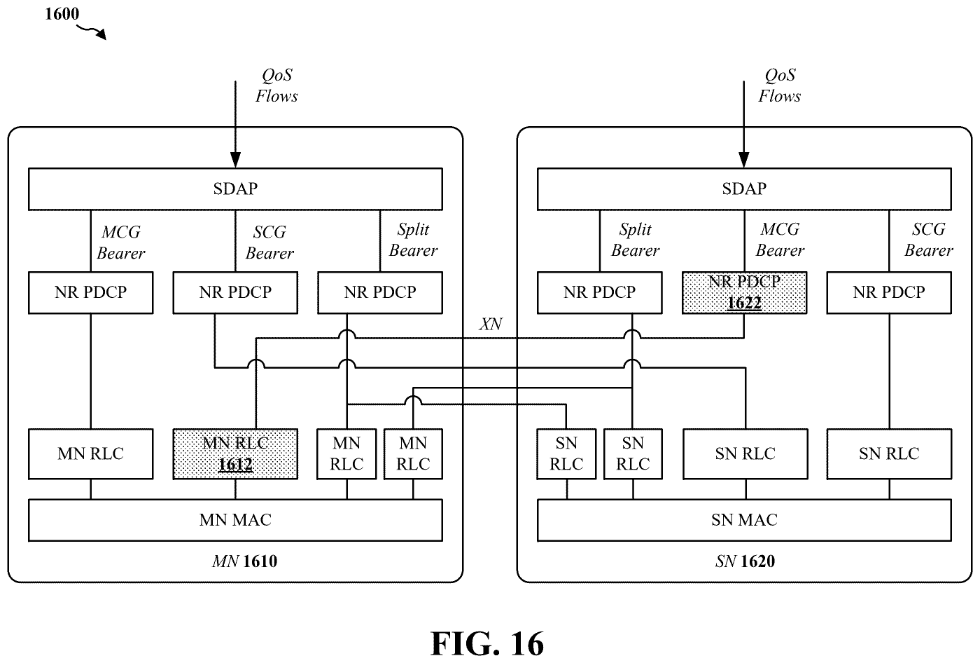

In some aspects, for the SN (e.g., SN 1620) to configure DRBs in the MN (e.g., MN 1610) with (e.g., for) ECN marking, a new Xn-AP DRB ECN marking or congestion information reporting request IE may be added to the S-node modification required message. FIG. 15 is a diagram illustrating an example S-node modification required message. As shown in FIG. 15, a S-node modification required message 1500 may include the DRB ECN marking or congestion information reporting request IE 1510. FIG. 16 is a diagram 1600 illustrating the network entities involved in the DRBs configuration in accordance with various aspects of the present disclosure. As shown in FIG. 16, the entities involved in the DRBs configuration (e.g., in FIG. 15) may include the MN RLC 1612 in the MN 1610 and NR PDCP 1622 in the SN 1620.

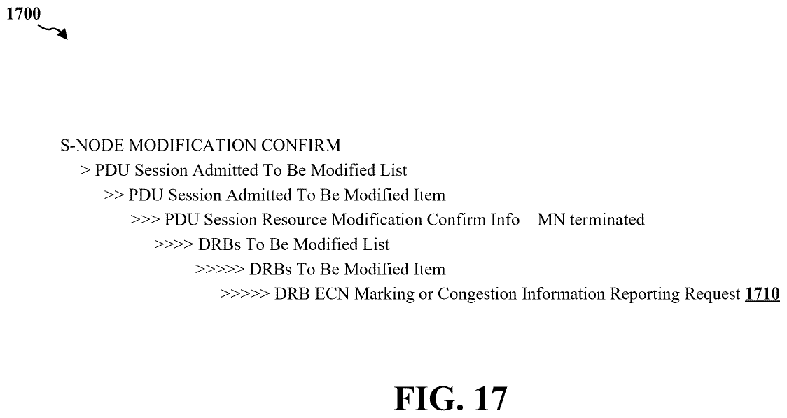

In some aspects, the new Xn-AP DRB ECN marking or congestion information reporting status IE may be added to the S-node modification confirm message. FIG. 17 is a diagram illustrating an example S-node modification confirm message. As shown in FIG. 17, a S-node modification confirm message 1700 may include the DRB ECN marking or congestion information reporting status IE 1710.

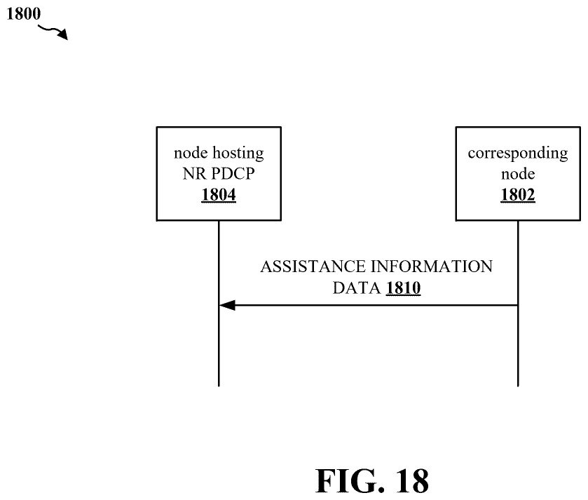

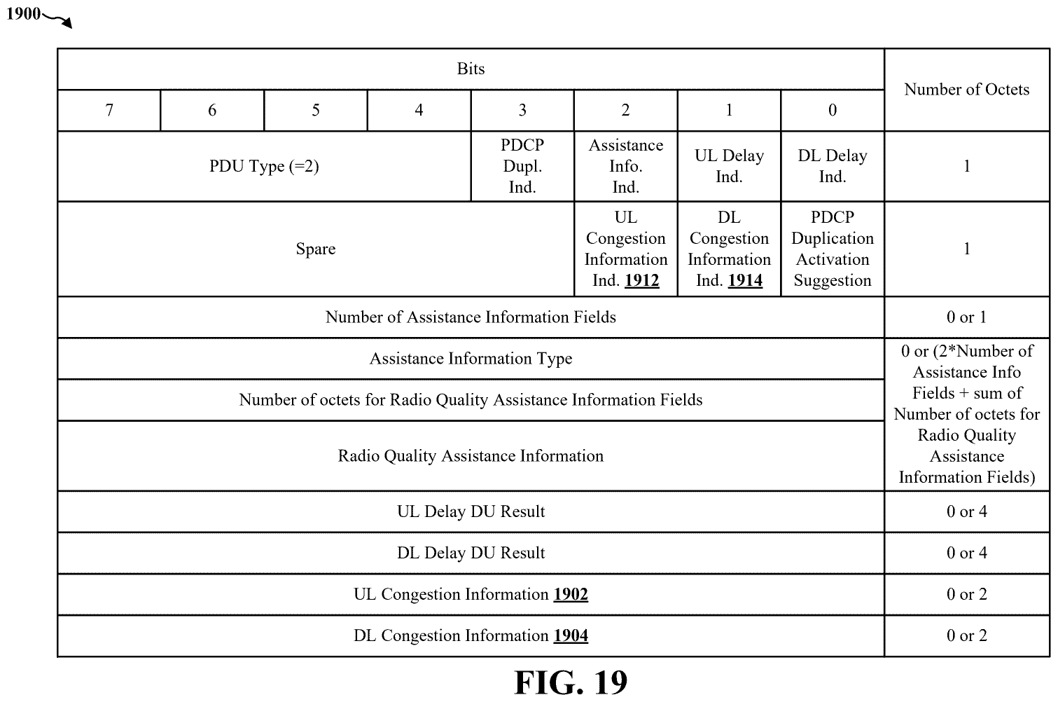

In some aspects, a network node may report IP packet congestion information to another network node through the DL congestion information and UL congestion information IEs of the assistance information data frame. FIG. 18 is a diagram 1800 illustrating an example of the transfer of assistance information data. For example, as shown in FIG. 18, a network node 1802 may report IP packet congestion information to another network node 1804. In some examples, the network node 1804 may be a node hosting NR PDCP. For example, the network node 1802 may report IP packet congestion information to network node 1804 through the DL congestion information and UL congestion information IEs. For example, the DL congestion information and UL congestion information IEs may be included in the assistance information data frame 1810. FIG. 19 is a diagram 1900 illustrating examples of DL congestion information and UL congestion information IEs of the assistance information data frame. As shown in FIG. 19, the UL congestion information 1902, the DL congestion information 1904, or both, may be included in the assistance information data frame.

In some aspects, if the bearer carries IP packets that belong to PDU sets, then the PDU set specific congestion information may be reported by the respective network node. For example, one or more IEs may be added to the assistance information data frame. These IEs may include one or more of: PDU Set DL congestion information IE (e.g., at 1904), PDU Set UL congestion information IE (e.g., at 1902), PDU Set DL congestion information indicator IE (e.g., at 1914), or PDU Set UL congestion information indicator IE (e.g., at 1912). Table 3 shows details of the IEs to be added to the assistance information data frame.

TABLE 3
IEs to be added to the assistance information data frame

| | | | Field |
|---|---|---|---|
| Parameter | Description | Value Range | Length |
| PDU Set DL | ECN marking Request: | {0 . . . 10000} | 2 octets |
| Congestion | Indicates the percentage of | | |
| Information | DL PDU sets up to two | | |
| | decimal points that should | | |
| | be ECN marked for a DRB | | |
| | Congestion Information | | |
| | Request: Interpreted as a | | |
| | percentage of PDU sets | | |
| | congestion level in DL up to | | |
| | two decimal points for a | | |
| | DRB | | |
| PDU Set UL | ECN marking Request: | {0 . . . 10000} | 2 octets |
| Congestion | Indicates the percentage of | | |
| Information | UL PDU sets up to two | | |
| | decimal points that should | | |
| | be ECN marked for a DRB | | |
| | Congestion Information | | |
| | Request: Interpreted as a | | |
| | percentage of PDU sets | | |
| | congestion level in UL up to | | |
| | two decimal points for a DR | | |
| PDU Set DL | Indicates the presence of | {0 = DL Congestion | 1 bit |
| Congestion | DL Congestion Information | Information not | |
| Information | | present, | |
| Indicator | | 1 = DL Congestion | |
| | | Information present} | |
| PDU Set UL | Indicates the presence of | {0 = UL Congestion | 1 bit |
| Congestion | UL Congestion Information | Information not | |
| Information | | present, | |
| Indicator | | 1 = UL Congestion | |
| | | Information present} | |

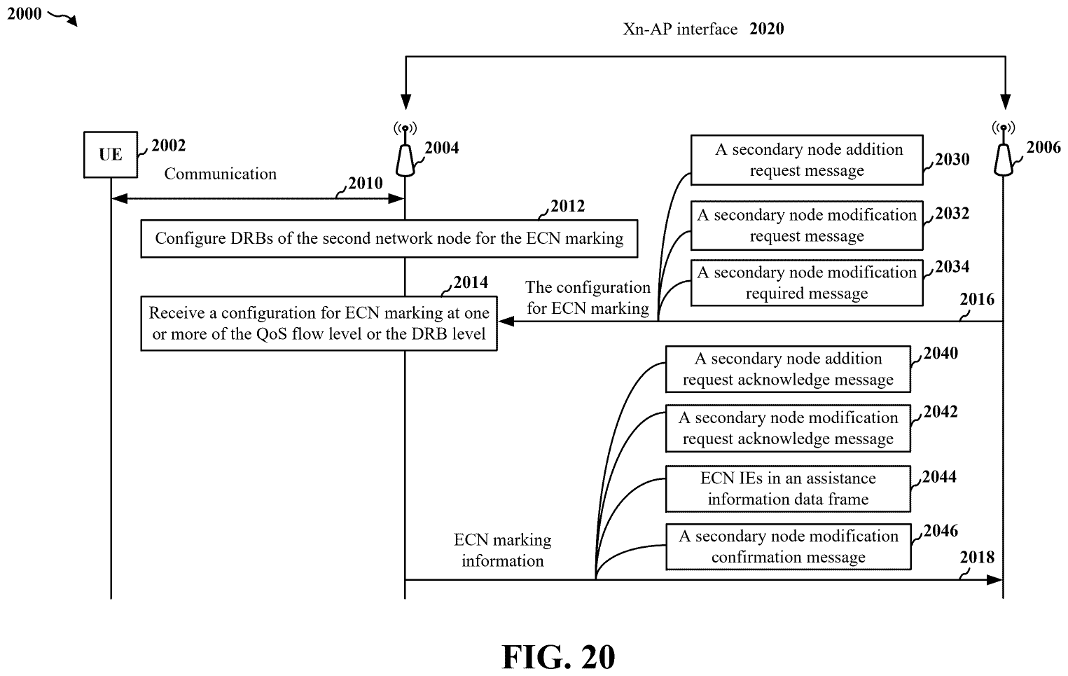

FIG. 20 is a call flow diagram 2000 illustrating a method of wireless communication in accordance with various aspects of this present disclosure. Various aspects are described in connection with a UE 2002, a first network node 2004, and a second network node 2006. Each of the first network node 2004 and the second network node 2006 may be a base station or one or more components of a base station (e.g., a CU 110, a DU 130, and/or an RU 140). The aspects may be performed by the UE 2002, the first network node 2004, or the second network node 2006 in aggregation and/or by one or more components of a base station (e.g., a CU 110, a DU 130, and/or an RU 140).

As shown in FIG. 20, the first network node 2004 may, at 2010, communicate with UE 2002 based on dual connectivity with the second network node 2006. In some examples, the first network node 2004 and the second network node 2006 may be associated with an XR application. In some examples, there may be an Xn-AP interface 2020 between the first network node 2004 and the second network node 2006. In some examples, the first network node 2004 may be the secondary node for the dual connectivity, and the second network node 2006 may be primary node for the dual connectivity. In some examples, the first network node 2004 may be the primary node for the dual connectivity, and the second network node 2006 may be secondary node for the dual connectivity.

In some aspects, at 2012, the first network node 2004 may configure DRBs of the second network node 2006 for the ECN marking.

At 2014, the first network node 2004 may receive a configuration for ECN marking at one or more of the QoS flow level or the DRB level. In some examples, the first network node 2004 may receive the configuration for ECN marking from the second network node 2006 at 2016.

In some examples, when the first network node 2004 is the secondary node for the dual connectivity, and the second network node 2006 is the primary node for the dual connectivity, the configuration for the ECN making may be included in one of a secondary node addition request message (e.g., 2030) or a secondary node modification request message (e.g., 2032). In some examples, the configuration for the ECN marking may configures DRBs in the first network node 2004 for the ECN marking.

In some examples, when the first network node 2004 is the primary node for the dual connectivity, and the second network node 2006 is the secondary node for the dual connectivity, the configuration for ECN marking may be included in a DRB ECN marking or congestion information reporting request in a secondary node modification required message (e.g., 2034).

In some aspects, at 2018, the first network node 2004 may provide ECN marking information to the second network node 2006. In some examples, the ECN marking information may be based on the configuration for the ECN marking (e.g., at 2014). In some examples, when providing the ECN marking information to the second network node 2006 at 2018, the first network node 2004 may provide a status for the ECN marking information via a status IE. The status IE may be included in one or more of: a secondary node addition request acknowledge message (e.g., 2040) or a secondary node modification request acknowledge message (e.g., 2042). In some examples, the status IE may be based on a list of one or more QoS flows for one of performing an ECN marking, reporting information for the ECN marking, or reporting congestion information.

In some examples, the one or more ECN IEs (e.g., 2044) may include one or more of: a PDU set DL congestion information IE (e.g., at 1904), a PDU set UL congestion information IE (e.g., at 1902), a PDU set DL congestion information indicator IE (e.g., at 1914), or a PDU set UL congestion information indicator IE (e.g., at 1912).

In some examples, the PDU set DL congestion information IE (e.g., at 1904) and the PDU set UL congestion information IE (e.g., at 1902) each may have a field length of two octets, and the PDU set DL congestion information indicator IE (e.g., at 1914) and the PDU set UL congestion information indicator IE (e.g., at 1912) each have the field length of 1 bit.

In some examples, the PDU set DL congestion information IE (e.g., at 1904) may indicate one or more of a first percentage of DL PDU sets that is ECN marked for a DRB or a second percentage of PDU sets congestion level in DL for the DRB.

In some examples, the PDU set UL congestion information IE (e.g., at 1902) may indicate one or more of a first percentage of UL PDU sets that is ECN marked for a DRB or a second percentage of PDU sets congestion level in UL for the DRB.

In some examples, the PDU set DL congestion information indicator IE (e.g., at 1914) may include an indicator that indicates a presence of DL congestion information.

In some examples, the PDU set UL congestion information indicator IE (e.g., at 1912) may include an indicator that indicates a presence of UL congestion information.

In some examples, to provide the ECN marking information (e.g., at 2018), the first network node 2004 may provide a status for the ECN marking information via the Xn-AP interface 2020.

In some examples, when the first network node 2004 is the primary node for the dual connectivity, and the second network node 2006 is the secondary node for the dual connectivity, the first network node 2004 may, at 2018, provide a DRB ECN marking or congestion information report status in a secondary node modification confirmation message (e.g., 2046).

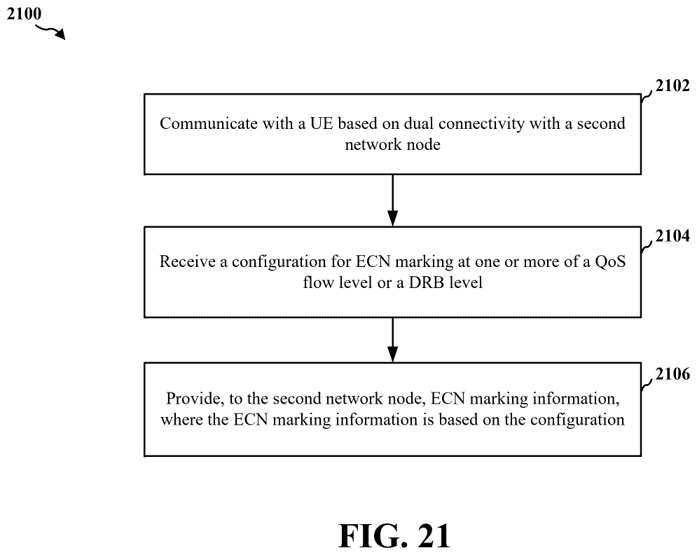

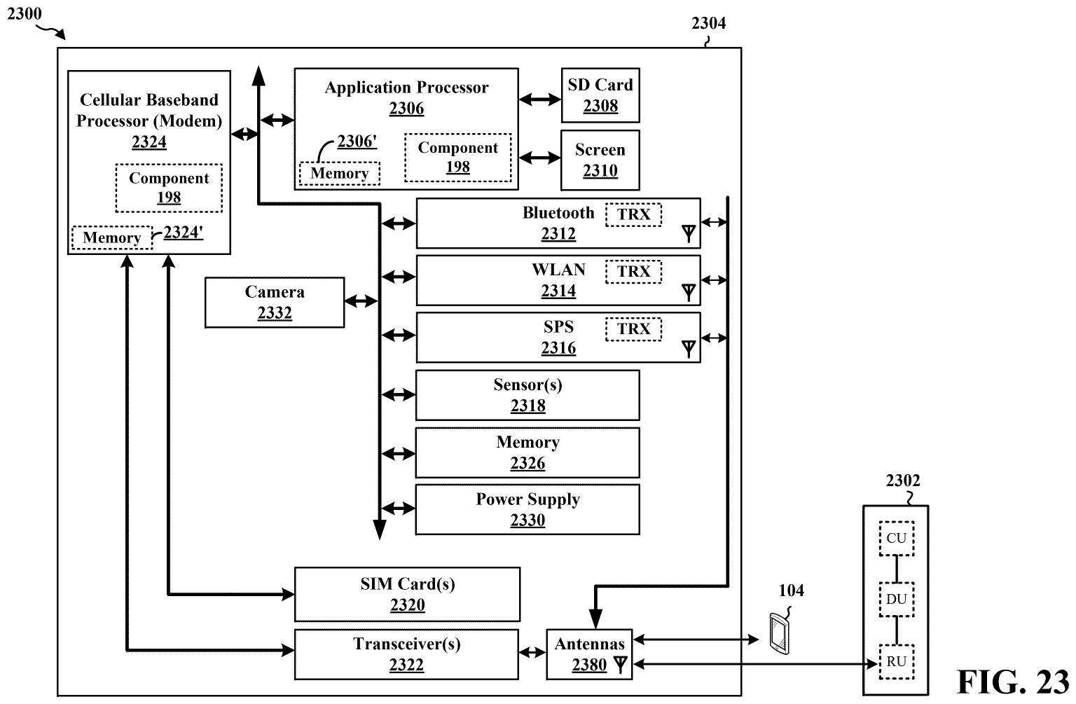

FIG. 21 is a flowchart 2100 illustrating methods of wireless communication at a first network node in accordance with various aspects of the present disclosure. The method may be performed by the first network node in collaboration with a UE and a second network node. The first network node may be a network entity. The network entity may be a base station, or a component of a base station, in the access network of FIG. 1 or a core network component (e.g., base station 102, 310; or the network entity 2302 in the hardware implementation of FIG. 23). In some examples, the first network node may be the first network node 2004. The second network node may be a network node that is different from the first network node. In some examples, the second network node may be another network entity, which may be a base station, or a component of a base station, in the access network of FIG. 1 or a core network component (e.g., base station 102, 310; or the network entity 2302 in the hardware implementation of FIG. 23). In some examples, the second network node may be the second network node 2006. The UE may be the UE 104, 350, 2002, or the apparatus 2304 in the hardware implementation of FIG. 23. By enabling the ECN marking in network nodes used in DC communication, the method may provide congestion information to the network nodes in DC at a QoS level or a DRB level, thereby enabling more efficient management of wireless communication according to the network conditions.

As shown in FIG. 21, at 2102, the first network node may communicate with a UE based on dual connectivity with the second network node. FIG. 6A, FIG. 6B, FIG. 7, FIG. 8A, FIG. 8B, FIG. 9, FIG. 10A, FIG. 10B, FIG. 11, FIG. 12, FIG. 13, FIG. 14A, FIG. 14B, FIG. 15, FIG. 16, FIG. 17, FIG. 18, FIG. 19, and FIG. 20 illustrate various aspects of the steps in connection with flowchart 2100. For example, referring to FIG. 20, the first network node 2004 may, at 2010, communicate with a UE 2002 based on dual connectivity with the second network node 2006. In some aspects, 2102 may be performed by ECN marking component 199.

At 2104, the first network node may receive a configuration for ECN marking at one or more of a QoS flow level or a DRB level. For example, referring to FIG. 20, the first network node 2004 may, at 2014, receive a configuration for ECN marking at one or more of a QoS flow level or a DRB level. In some aspects, 2104 may be performed by ECN marking component 199.

At 2106, the first network node may provide, to the second network node, ECN marking information. The ECN marking information is based on the configuration. For example, referring to FIG. 20, the first network node 2004 may, at 2018, provide to the second network node 2006 ECN marking information. The ECN marking information may be based on the configuration for ECN marking (e.g., at 2014). In some aspects, 2106 may be performed by ECN marking component 199.

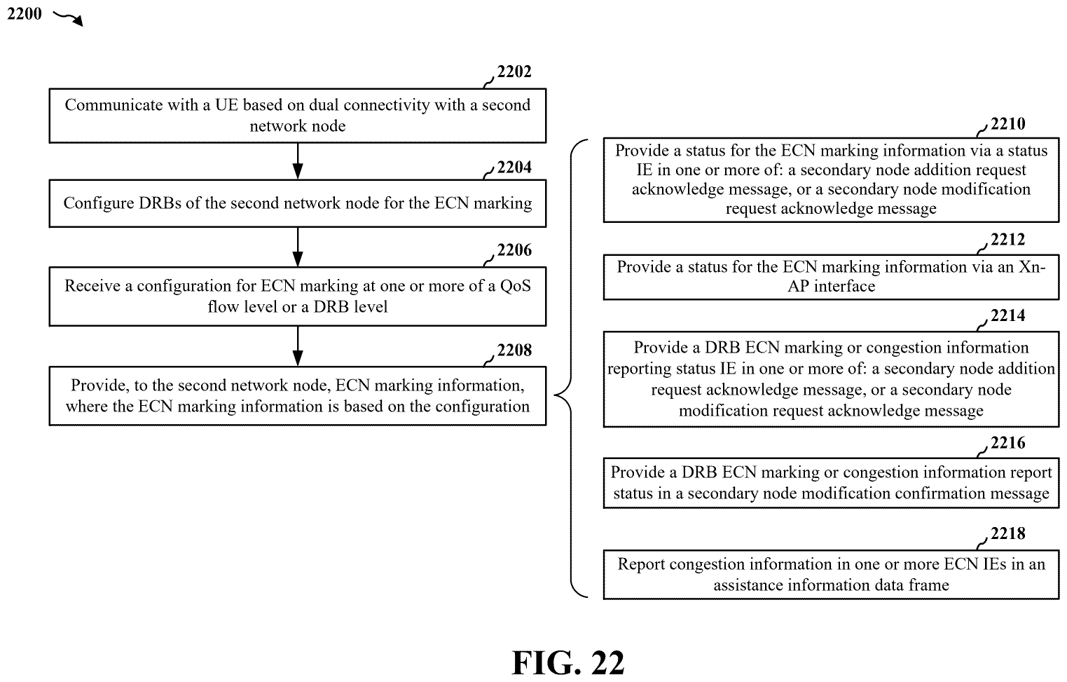

FIG. 22 is a flowchart 2200 illustrating methods of wireless communication at a first network node in accordance with various aspects of the present disclosure. The method may be performed by the first network node in collaboration with a UE and a second network node. The first network node may be a network entity. The network entity may be a base station, or a component of a base station, in the access network of FIG. 1 or a core network component (e.g., base station 102, 310; or the network entity 2302 in the hardware implementation of FIG. 23). In some examples, the first network node may be the first network node 2004. The second network node may be a network node that is different from the first network node. In some examples, the second network node may be another network entity, which may be a base station, or a component of a base station, in the access network of FIG. 1 or a core network component (e.g., base station 102, 310; or the network entity 2302 in the hardware implementation of FIG. 23). In some examples, the second network node may be the second network node 2006. The UE may be the UE 104, 350, 2002, or the apparatus 2304 in the hardware implementation of FIG. 23. By enabling the ECN marking in network nodes used in DC communication, the method may provide congestion information to the network nodes in DC at a QoS level or a DRB level, thereby enabling more efficient management of wireless communication according to the network conditions.

As shown in FIG. 22, at 2202, the first network node may communicate with a UE based on dual connectivity with a second network node. FIG. 6A, FIG. 6B, FIG. 7, FIG. 8A, FIG. 8B, FIG. 9, FIG. 10A, FIG. 10B, FIG. 11, FIG. 12, FIG. 13, FIG. 14A, FIG. 14B, FIG. 15, FIG. 16, FIG. 17, FIG. 18, FIG. 19, and FIG. 20 illustrate various aspects of the steps in connection with flowchart 2200. For example, referring to FIG. 20, the first network node 2004 may, at 2010, communicate with a UE 2002 based on dual connectivity with the second network node 2006. In some aspects, 2202 may be performed by ECN marking component 199.

At 2206, the first network node may receive a configuration for ECN marking at one or more of a QoS flow level or a DRB level. For example, referring to FIG. 20, the first network node 2004 may, at 2014, receive a configuration for ECN marking at one or more of a QoS flow level or a DRB level. In some aspects, 2206 may be performed by ECN marking component 199.

At 2208, the first network node may provide, to the second network node, ECN marking information. The ECN marking information is based on the configuration. For example, referring to FIG. 20, the first network node 2004 may, at 2018, provide to the second network node 2006 ECN marking information. The ECN marking information may be based on the configuration for ECN marking (e.g., at 2014). In some aspects, 2208 may be performed by ECN marking component 199.

In some aspects, the dual connectivity with the second network node may be associated with an XR application. For example, referring to FIG. 20, the dual connectivity with the second network node 2006 may be associated with an XR application.

In some aspects, the first network node may be a secondary node for the dual connectivity, and the second network node may be a primary node for the dual connectivity. For example, referring to FIG. 20, in some examples, the first network node 2004 may be the secondary node for the dual connectivity, and the second network node 2006 may be the primary node for the dual connectivity.

In some aspects, the configuration for the ECN marking may be included in an ECN marking or congestion information reporting request in one or more of: a secondary node addition request message, or a secondary node modification request message. For example, referring to FIG. 20, the configuration for the ECN marking (e.g., at 2014) may be included in an ECN marking or congestion information reporting request in one or more of: a secondary node addition request message (e.g., 2030) or a secondary node modification request message (e.g., 2032). Referring to FIG. 6A and FIG. 6B, the secondary node addition request message may be the S-node addition request message 600, and the secondary node modification request message may be the S-node modification request message 650.

In some aspects, to provide the ECN marking information (e.g., at 2208), the first network node may, at 2210, provide a status for the ECN marking information via a status IE in one or more of: a secondary node addition request acknowledge message or a secondary node modification request acknowledge message. For example, referring to FIG. 20, the first network node 2004 may provide a status for the ECN marking information via a status IE in one or more of: a secondary node addition request acknowledge message (e.g., 2040) or a secondary node modification request acknowledge message (e.g., 2042). Referring to FIG. 7, FIG. 8A, and FIG. 8B, the status IE may be IE 700. The secondary node addition request acknowledge message may be the S-node addition request acknowledge message 800, and the secondary node modification request acknowledge message may be the S-node modification request acknowledge message 850. In some aspects, 2210 may be performed by ECN marking component 199.

In some aspects, the status IE may be based on a list of one or more QoS flows for one of: performing an ECN marking, reporting information for the ECN marking, or reporting congestion information. For example, referring to FIG. 7, the status IE (e.g., IE 700) may be based on a list of one or more QoS flows for one of: performing an ECN marking, reporting information for the ECN marking, or reporting congestion information.

In some aspects, to provide the ECN marking information (e.g., at 2208), the first network node may, at 2212, provide a status for the ECN marking information via an Xn application protocol (Xn-AP) interface. For example, referring to FIG. 20, the first network node 2004 may provide a status for the ECN marking information via an Xn-AP interface 2020. In some aspects, 2212 may be performed by ECN marking component 199.

In some aspects, when receiving the configuration for the ECN marking, the first network node may receive the configuration for the ECN marking from the primary node, and the configuration may configure DRBs in the secondary node for the ECN marking. For example, referring to FIG. 20, the first network node 2004 may, at 2016, receive the configuration for the ECN marking from the primary node (e.g., the second network node 2006), and the configuration may configure DRBs in the secondary node (e.g., the first network node 2004) for the ECN marking.

In some aspects, the configuration may be included in a DRB ECN marking or congestion information reporting request in one or more of: a secondary node addition request message (e.g., message 1000), or a secondary node modification request message (e.g., message 1050). For example, referring to FIG. 20, the configuration may be included in a DRB ECN marking or congestion information reporting request in one or more of: a secondary node addition request message (e.g., 2030) or a secondary node modification request message (e.g., 2032). Referring to FIG. 10A and FIG. 10B, the secondary node addition request message may be the S-node addition request message 1000, and the secondary node modification request message may be the S-node modification request message 1050.

In some aspects, the configuration may be included in a DRB ECN marking or congestion information reporting request IE (e.g., IE 1200) for an Xn-AP interface and may have the same structure as the DRB ECN marking or congestion information reporting request IE for an F1 interface. For example, referring to FIG. 20, the configuration (e.g., at 2014) may be included in a DRB ECN marking or congestion information reporting request IE for an Xn-AP interface 2020 and may have the same structure as the DRB ECN marking or congestion information reporting request IE for an F1 interface. Referring to FIG. 12, the DRB ECN marking or congestion information reporting request IE may be the DRB ECN marking or congestion information reporting request IE 1200.

In some aspects, to provide the ECN marking information (e.g., at 2208), the first network node may, at 2214, provide a DRB ECN marking or congestion information reporting status IE (e.g., IE 1300) in one or more of: a secondary node addition request acknowledge message (e.g., message 1400), or a secondary node modification request acknowledge message (e.g., message 1450). For example, referring to FIG. 20, the first network node 2004 may provide a DRB ECN marking or congestion information reporting status IE in one or more of: a secondary node addition request acknowledge message (e.g., 2040), or a secondary node modification request acknowledge message (e.g., 2042). Referring to FIG. 13, FIG. 14A, and FIG. 14B, the DRB ECN marking or congestion information reporting status IE may be the DRB ECN marking or congestion information reporting status IE 1300. The secondary node addition request acknowledge message may be the S-node addition request acknowledge message 1400, and the secondary node modification request acknowledge message may be the S-node modification request acknowledge message 1450. In some aspects, 2214 may be performed by ECN marking component 199.

In some aspects, the DRB ECN marking or congestion information reporting status IE for an Xn application protocol (Xn-AP) interface may have the same structure as the DRB ECN marking or congestion information reporting status IE for an F1 interface. For example, referring to FIG. 20, the DRB ECN marking or congestion information reporting status IE (e.g., DRB ECN marking or congestion information reporting status IE 1300) for the Xn-AP interface 2020 may have the same structure as the DRB ECN marking or congestion information reporting status IE for an F1 interface.

In some aspects, at 2204, the first network node may further configure DRBs of the second network node for the ECN marking. For example, referring to FIG. 20, the first network node 2004 may, at 2012, configure DRBs of the second network node 2006 for the ECN marking. In some aspects, 2204 may be performed by ECN marking component 199.

In some aspects, the first network node may be a primary node for the dual connectivity, and the second network node may be a secondary node for the dual connectivity. For example, referring to FIG. 20, in some examples, the first network node 2004 may be the primary node for the dual connectivity, and the second network node 2006 may be the secondary node for the dual connectivity.

In some aspects, the configuration may be included in a DRB ECN marking or congestion information reporting request in a secondary node modification required message. For example, referring to FIG. 20, the configuration (e.g., at 2014) may be included in a DRB ECN marking or congestion information reporting request in a secondary node modification required message (e.g., 2032). Referring to FIG. 15, the secondary node modification required message may be the S-node modification required message 1500.

In some aspects, to provide the ECN marking information (e.g., at 2208), the first network node may, at 2216, provide a DRB ECN marking or congestion information report status in a secondary node modification confirmation message (e.g., message 1700). For example, referring to FIG. 20, the first network node 2004 may, at 2018, provide a DRB ECN marking or congestion information report status in a secondary node modification confirmation message (e.g., 2046). Referring to FIG. 17, the secondary node modification confirmation message may be the S-node modification confirm message 1700. In some aspects, 2216 may be performed by ECN marking component 199.

In some aspects, to provide the ECN marking information (e.g., at 2208), the first network node may, at 2218, report congestion information in one or more ECN IEs in an assistance information data frame. For example, referring to FIG. 20, the first network node 2004 may, at 2018, report congestion information in one or more ECN IEs in an assistance information data frame (e.g., 2044). In some aspects, 2218 may be performed by ECN marking component 199.

In some aspects, the one or more ECN IEs may include one or more of a PDU set downlink (DL) congestion information IE, a PDU set uplink (UL) congestion information IE, a PDU set DL congestion information indicator IE, or a PDU set UL congestion information indicator IE. For example, referring to FIG. 19, the one or more ECN IEs may include one or more of a PDU set downlink (DL) congestion information IE (e.g., 1904), a PDU set uplink (UL) congestion information IE (e.g., 1902), a PDU set DL congestion information indicator IE (e.g., 1914), or a PDU set UL congestion information indicator IE (e.g., 1912).

In some aspects, the PDU set DL congestion information IE and the PDU set UL congestion information IE may each have a field length of two octets, and the PDU set DL congestion information indicator IE and the PDU set UL congestion information indicator IE may each have the field length of 1 bit. For example, referring to Table 3, the PDU set DL congestion information IE and the PDU set UL congestion information IE may each have a field length of two octets, and the PDU set DL congestion information indicator IE and the PDU set UL congestion information indicator IE may each have the field length of 1 bit.

In some aspects, the PDU set DL congestion information IE may indicate one or more of a first percentage of DL PDU sets that is ECN marked for a DRB or a second percentage of PDU sets congestion level in DL for the DRB. For example, referring to Table 3, the PDU set DL congestion information IE may indicate one or more of a first percentage of DL PDU sets that is ECN marked for a DRB or a second percentage of PDU sets congestion level in DL for the DRB.

In some aspects, the PDU set UL congestion information IE may indicate one or more of a first percentage of UL PDU sets that is ECN marked for a DRB or a second percentage of PDU sets congestion level in UL for the DRB. For example, referring to Table 3, the PDU set UL congestion information IE may indicate one or more of a first percentage of UL PDU sets that is ECN marked for a DRB or a second percentage of PDU sets congestion level in UL for the DRB.

In some aspects, the PDU set DL congestion information indicator IE may include an indicator that indicates the presence of DL congestion information. For example, referring to Table 3, the PDU set DL congestion information indicator IE may include an indicator that indicates the presence of DL congestion information.

In some aspects, the PDU set UL congestion information indicator IE may include an indicator that indicates the presence of UL congestion information. For example, referring to Table 3, the PDU set UL congestion information indicator IE may include an indicator that indicates the presence of UL congestion information.

FIG. 23 is a diagram 2300 illustrating an example of a hardware implementation for an apparatus 2304. The apparatus 2304 may be a UE, a component of a UE, or may implement UE functionality. In some aspects, the apparatus 2304 may include at least one cellular baseband processor (or processing circuitry) 2324 (also referred to as a modem) coupled to one or more transceivers 2322 (e.g., cellular RF transceiver). The cellular baseband processor(s) (or processing circuitry) 2324 may include at least one on-chip memory (or memory circuitry) 2324′. In some aspects, the apparatus 2304 may further include one or more subscriber identity modules (SIM) cards 2320 and at least one application processor (or processing circuitry) 2306 coupled to a secure digital (SD) card 2308 and a screen 2310. The application processor(s) (or processing circuitry) 2306 may include on-chip memory (or memory circuitry) 2306′. In some aspects, the apparatus 2304 may further include a Bluetooth module 2312, a WLAN module 2314, an SPS module 2316 (e.g., GNSS module), one or more sensor modules 2318 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2326, a power supply 2330, and/or a camera 2332. The Bluetooth module 2312, the WLAN module 2314, and the SPS module 2316 may include an on-chip transceiver (TRX) (or in some cases, just a receiver (RX)). The Bluetooth module 2312, the WLAN module 2314, and the SPS module 2316 may include their own dedicated antennas and/or utilize the antennas 2380 for communication. The cellular baseband processor(s) (or processing circuitry) 2324 communicates through the transceiver(s) 2322 via one or more antennas 2380 with the UE 104 and/or with an RU associated with a network entity 2302. The cellular baseband processor(s) (or processing circuitry) 2324 and the application processor(s) (or processing circuitry) 2306 may each include a computer-readable medium/memory (or memory circuitry) 2324′, 2306′, respectively. The additional memory modules 2326 may also be considered a computer-readable medium/memory (or memory circuitry). Each computer-readable medium/memory (or memory circuitry) 2324′, 2306′, 2326 may be non-transitory. The cellular baseband processor(s) (or processing circuitry) 2324 and the application processor(s) (or processing circuitry) 2306 are each responsible for general processing, including the execution of software stored on the computer-readable medium/memory (or memory circuitry). The software, when executed by the cellular baseband processor(s) (or processing circuitry) 2324/application processor(s) (or processing circuitry) 2306, causes the cellular baseband processor(s) (or processing circuitry) 2324/application processor(s) (or processing circuitry) 2306 to perform the various functions described supra. The cellular baseband processor(s) (or processing circuitry) 2324 and the application processor(s) (or processing circuitry) 2306 are configured to perform the various functions described supra based at least in part of the information stored in the memory (or memory circuitry). That is, the cellular baseband processor(s) (or processing circuitry) 2324 and the application processor(s) (or processing circuitry) 2306 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 2324/application processor(s) (or processing circuitry) 2306 when executing software. The cellular baseband processor(s) (or processing circuitry) 2324/application processor(s) (or processing circuitry) 2306 may be a component of the UE 350 and may include the at least one memory 360 and/or at least one of the TX processor 368, the RX processor 356, and the controller/processor 359. In one configuration, the apparatus 2304 may be at least one processor chip (modem and/or application) and include just the cellular baseband processor(s) (or processing circuitry) 2324 and/or the application processor(s) (or processing circuitry) 2306, and in another configuration, the apparatus 2304 may be the entire UE (e.g., sec UE 350 of FIG. 3) and include the additional modules of the apparatus 2304.

As discussed supra, the component 198 may be configured to perform any of the aspects performed by the UE 2002 in FIG. 20. The component 198 may be within the cellular baseband processor(s) (or processing circuitry) 2324, the application processor(s) (or processing circuitry) 2306, or both the cellular baseband processor(s) (or processing circuitry) 2324 and the application processor(s) (or processing circuitry) 2306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2304 may include a variety of components configured for various functions. In one configuration, the apparatus 2304, and in particular the cellular baseband processor(s) (or processing circuitry) 2324 and/or the application processor(s) (or processing circuitry) 2306, includes means for performing any of the aspects performed by the UE 2002 in FIG. 20. The means may be the component 198 of the apparatus 2304 configured to perform the functions recited by the means. As described supra, the apparatus 2304 may include the TX processor 368, the RX processor 356, and the controller/processor 359. As such, in one configuration, the means may be the TX processor 368, the RX processor 356, and/or the controller/processor 359 configured to perform the functions recited by the means.

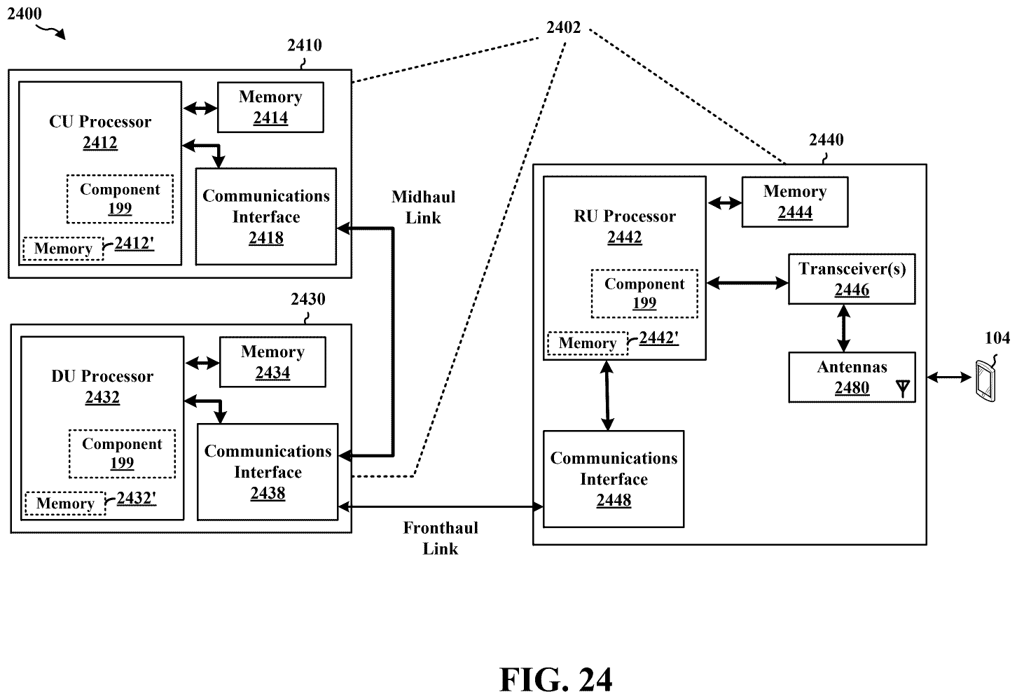

FIG. 24 is a diagram 2400 illustrating an example of a hardware implementation for a network entity 2402. The network entity 2402 may be a BS, a component of a BS, or may implement BS functionality. The network entity 2402 may include at least one of a CU 2410, a DU 2430, or an RU 2440. For example, depending on the layer functionality handled by the component 199, the network entity 2402 may include the CU 2410; both the CU 2410 and the DU 2430; each of the CU 2410, the DU 2430, and the RU 2440; the DU 2430; both the DU 2430 and the RU 2440; or the RU 2440. The CU 2410 may include at least one CU processor (or processing circuitry) 2412. The CU processor(s) (or processing circuitry) 2412 may include on-chip memory (or memory circuitry) 2412′. In some aspects, the CU 2410 may further include additional memory modules 2414 and a communications interface 2418. The CU 2410 communicates with the DU 2430 through a midhaul link, such as an F1 interface. The DU 2430 may include at least one DU processor (or processing circuitry) 2432. The DU processor(s) (or processing circuitry) 2432 may include on-chip memory (or memory circuitry) 2432′. In some aspects, the DU 2430 may further include additional memory modules 2434 and a communications interface 2438. The DU 2430 communicates with the RU 2440 through a fronthaul link. The RU 2440 may include at least one RU processor (or processing circuitry) 2442. The RU processor(s) (or processing circuitry) 2442 may include on-chip memory (or memory circuitry) 2442′. In some aspects, the RU 2440 may further include additional memory modules 2444, one or more transceivers 2446, antennas 2480, and a communications interface 2448. The RU 2440 communicates with the UE 104. The on-chip memory (or memory circuitry) 2412′, 2432′, 2442′ and the additional memory modules 2414, 2434, 2444 may each be considered a computer-readable medium/memory (or memory circuitry). Each computer-readable medium/memory (or memory circuitry) may be non-transitory. Each of the processors (or processing circuitry) 2412, 2432, 2442 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to communicate with a UE based on dual connectivity with a second network node; receive a configuration for ECN marking at one or more of a QoS flow level or a DRB level; and provide, to the second network node, ECN marking information, where the ECN marking information is based on the configuration. The component 199 may be further configured to perform any of the aspects described in connection with the flowcharts in FIG. 21 and FIG. 22, and/or performed by the first network node 2004 in FIG. 20. The component 199 may be within one or more processors (or processing circuitry) of one or more of the CU 2410, DU 2430, and the RU 2440. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2402 may include a variety of components configured for various functions. In one configuration, the network entity 2402 includes means for communicating with a UE based on dual connectivity with a second network node, means for receiving a configuration for ECN marking at one or more of a QoS flow level or a DRB level, and means for providing, to the second network node, ECN marking information, where the ECN marking information is based on the configuration. The network entity 2402 may further include means for performing any of the aspects described in connection with the flowcharts in FIG. 21 and FIG. 22, and/or aspects performed by the first network node 2004 in FIG. 20. The means may be the component 199 of the network entity 2402 configured to perform the functions recited by the means. As described supra, the network entity 2402 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a first network node. The method may include communicating with a UE based on dual connectivity with a second network node; receiving a configuration for ECN marking at one or more of a QoS flow level or a DRB level; and providing, to the second network node, ECN marking information, where the ECN marking information is based on the configuration. By enabling the ECN marking in network nodes used in DC communication, the method may provide congestion information to the network nodes in DC at a QoS level or a DRB level, thereby enabling more efficient management of wireless communication according to the network conditions.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network node. The method includes communicating with a user equipment (UE) based on dual connectivity with a second network node; receiving a configuration for explicit congestion notification (ECN) marking at one or more of a quality of service (QoS) flow level or a data radio bearer (DRB) level; and providing, to the second network node, ECN marking information, wherein the ECN marking information is based on the configuration.

Aspect 2 is the method of aspect 1, wherein the dual connectivity with the second network node is associated with an extended reality (XR) application.

Aspect 3 is the method of any of aspects 1 to 2, wherein the first network node is a secondary node for the dual connectivity, and the second network node is a primary node for the dual connectivity.

Aspect 4 is the method of aspect 3, wherein the configuration for the ECN marking is comprised in an ECN marking or congestion information reporting request in one or more of: a secondary node addition request message, or a secondary node modification request message.

Aspect 5 is the method of aspect 3, wherein providing the ECN marking information comprises: providing a status for the ECN marking information via a status information element (IE) in one or more of: a secondary node addition request acknowledge message, or a secondary node modification request acknowledge message.

Aspect 6 is the method of aspect 5, wherein the status IE is based on a list of one or more QoS flows for one of: performing an ECN marking, reporting information for the ECN marking, or reporting congestion information.

Aspect 7 is the method of aspect 3, wherein providing the ECN marking information comprises: providing a status for the ECN marking information via an Xn application protocol (Xn-AP) interface.

Aspect 8 is the method of aspect 3, wherein receiving the configuration for the ECN marking comprises: receiving, from the primary node, the configuration for the ECN marking, and wherein the configuration configures DRBs in the secondary node for the ECN marking.

Aspect 9 is the method of aspect 8, wherein the configuration is comprised in a DRB ECN marking or congestion information reporting request in one or more of: a secondary node addition request message, or a secondary node modification request message.

Aspect 10 is the method of aspect 8, wherein the configuration is comprised in a DRB ECN marking or congestion information reporting request information element (IE) for an Xn application protocol (Xn-AP) interface and having a same structure as the DRB ECN marking or congestion information reporting request IE for an F1 interface.

Aspect 11 is the method of aspect 8, wherein providing the ECN marking information comprises: providing a DRB ECN marking or congestion information reporting status information element (IE) in one or more of: a secondary node addition request acknowledge message, or a secondary node modification request acknowledge message.

Aspect 12 is the method of aspect 8, wherein the DRB ECN marking or congestion information reporting status IE for an Xn application protocol (Xn-AP) interface has a same structure as the DRB ECN marking or congestion information reporting status IE for an F1 interface.

Aspect 13 is the method of aspect 3, where the method further includes configuring DRBs of the second network node for the ECN marking.

Aspect 14 is the method of any of aspects 1 to 2, wherein the first network node is a primary node for the dual connectivity, and the second network node is a secondary node for the dual connectivity.

Aspect 15 is the method of aspect 14, wherein the configuration is comprised in a DRB ECN marking or congestion information reporting request in a secondary node modification required message.

Aspect 16 is the method of aspect 15, wherein providing the ECN marking information comprises: providing a DRB ECN marking or congestion information report status in a secondary node modification confirmation message.

Aspect 17 is the method of any of aspects 1 to 2, wherein providing the ECN marking information includes: reporting congestion information in one or more ECN information elements (IEs) in an assistance information data frame.

Aspect 18 is the method of aspect 17, wherein the one or more ECN IEs include one or more of: a protocol data unit (PDU) set downlink (DL) congestion information IE, a PDU set uplink (UL) congestion information IE, a PDU set DL congestion information indicator IE, or a PDU set UL congestion information indicator IE.

Aspect 19 is the method of aspect 18, wherein the PDU set DL congestion information IE and the PDU set UL congestion information IE each have a field length of two octets, and the PDU set DL congestion information indicator IE and the PDU set UL congestion information indicator IE each have the field length of 1 bit.

Aspect 20 is the method of aspect 18, wherein the PDU set DL congestion information IE indicates one or more of a first percentage of DL PDU sets that is ECN marked for a DRB or a second percentage of PDU sets congestion level in DL for the DRB.

Aspect 21 is the method of aspect 18, wherein the PDU set UL congestion information IE indicates one or more of a first percentage of UL PDU sets that is ECN marked for a DRB or a second percentage of PDU sets congestion level in UL for the DRB.

Aspect 22 is the method of aspect 18, wherein the PDU set DL congestion information indicator IE includes an indicator that indicates a presence of DL congestion information.

Aspect 23 is the method of aspect 18, wherein the PDU set UL congestion information indicator IE includes an indicator that indicates a presence of UL congestion information.

Aspect 24 is an apparatus for wireless communication at a first network node, comprising: a processing system that includes processor circuitry and memory circuitry that stores code and is coupled with the processor circuitry, the processing system configured to cause the first network node to perform the method of one or more of aspects 1-23.

Aspect 25 is an apparatus for wireless communication at a first network node, comprising: at least one memory; and at least one processor coupled to the at least one memory and, where the at least one processor is configured to perform the method of any of aspects 1-23.

Aspect 26 is the apparatus for wireless communication at a first network node, comprising means for performing each step in the method of any of aspects 1-23.

Aspect 27 is an apparatus of any of aspects 24-26, further comprising a transceiver configured to receive or to transmit in association with the method of any of aspects 1-23.

Aspect 28 is a computer-readable medium (e.g., a non-transitory computer-readable medium) storing computer executable code at a first network node, the code when executed by at least one processor causes the at least one processor to perform the method of any of aspects 1-23.

What is claimed is:

1. An apparatus for wireless communication at a first network node, comprising:
at least one memory; and
at least one processor coupled to the at least one memory and, based at least in part on information stored in the at least one memory, the at least one processor is configured to cause the first network node to:
communicate with a user equipment (UE) based on dual connectivity with a second network node;
receive a configuration for explicit congestion notification (ECN) marking at one or more of a quality of service (QoS) flow level or a data radio bearer (DRB) level; and
provide, to the second network node, ECN marking information, wherein the ECN marking information is based on the configuration.

2. The apparatus of claim 1, further comprising a transceiver coupled to the at least one processor, wherein to communicate with the UE based on the dual connectivity with the second network node, the at least one processor is configured to cause the first network node to communicate with the UE based on the dual connectivity with the second network node via the transceiver, wherein the dual connectivity with the second network node is associated with an extended reality (XR) application.

3. The apparatus of claim 1, wherein the first network node is a secondary node for the dual connectivity, and the second network node is a primary node for the dual connectivity.

4. The apparatus of claim 3, wherein the configuration for the ECN marking is comprised in an ECN marking or congestion information reporting request in one or more of:
a secondary node addition request message, or
a secondary node modification request message.

5. The apparatus of claim 3, wherein to provide the ECN marking information, the at least one processor is configured to cause the first network node to:
provide a status for the ECN marking information via a status information element (IE) in one or more of:
a secondary node addition request acknowledge message, or
a secondary node modification request acknowledge message.

6. The apparatus of claim 5, wherein the status IE is based on a list of one or more QoS flows for one of:
performing an ECN marking,
reporting information for the ECN marking, or
reporting congestion information.

7. The apparatus of claim 3, wherein to provide the ECN marking information, the at least one processor is configured to cause the first network node to:
provide a status for the ECN marking information via an Xn application protocol (Xn-AP) interface.

8. The apparatus of claim 3, wherein to receive the configuration for the ECN marking, the at least one processor is configured to cause the first network node to:
receive, from the primary node, the configuration for the ECN marking, wherein the configuration configures DRBs in the secondary node for the ECN marking.

9. The apparatus of claim 8, wherein the configuration is comprised in a DRB ECN marking or congestion information reporting request in one or more of:
a secondary node addition request message, or
a secondary node modification request message.

10. The apparatus of claim 8, wherein the configuration is comprised in a DRB ECN marking or congestion information reporting request information element (IE) for an Xn application protocol (Xn-AP) interface and having a same structure as the DRB ECN marking or congestion information reporting request IE for an F1 interface.

11. The apparatus of claim 8, wherein to provide the ECN marking information, the at least one processor is configured to cause the first network node to:
provide a DRB ECN marking or congestion information reporting status information element (IE) in one or more of:
a secondary node addition request acknowledge message, or
a secondary node modification request acknowledge message.

12. The apparatus of claim 8, wherein the DRB ECN marking or congestion information reporting status IE for an Xn application protocol (Xn-AP) interface has a same structure as the DRB ECN marking or congestion information reporting status IE for an F1 interface.

13. The apparatus of claim 3, wherein the at least one processor is further configured to cause the first network node to:
configure DRBs of the second network node for the ECN marking.

14. The apparatus of claim 1, wherein the first network node is a primary node for the dual connectivity, and the second network node is a secondary node for the dual connectivity.

15. The apparatus of claim 14, wherein the configuration is comprised in a DRB ECN marking or congestion information reporting request in a secondary node modification required message.

16. The apparatus of claim 15, wherein to provide the ECN marking information, the at least one processor is configured to cause the first network node to:
provide a DRB ECN marking or congestion information report status in a secondary node modification confirmation message.

17. The apparatus of claim 1, wherein to provide the ECN marking information, the at least one processor is configured to cause the first network node to:
report congestion information in one or more ECN information elements (IEs) in an assistance information data frame.

18. The apparatus of claim 17, wherein the one or more ECN IEs include one or more of:
a protocol data unit (PDU) set downlink (DL) congestion information IE,
a PDU set uplink (UL) congestion information IE,
a PDU set DL congestion information indicator IE, or
a PDU set UL congestion information indicator IE.

19. The apparatus of claim 18, wherein the PDU set DL congestion information IE and the PDU set UL congestion information IE each have a field length of two octets, and the PDU set DL congestion information indicator IE and the PDU set UL congestion information indicator IE each have the field length of 1 bit.

20. The apparatus of claim 18, wherein the PDU set DL congestion information IE indicates one or more of a first percentage of DL PDU sets that is ECN marked for a DRB or a second percentage of PDU sets congestion level in DL for the DRB.

21. The apparatus of claim 18, wherein the PDU set UL congestion information IE indicates one or more of a first percentage of UL PDU sets that is ECN marked for a DRB or a second percentage of PDU sets congestion level in UL for the DRB.

22. The apparatus of claim 18, wherein the PDU set DL congestion information indicator IE includes an indicator that indicates a presence of DL congestion information.

23. The apparatus of claim 18, wherein the PDU set UL congestion information indicator IE includes an indicator that indicates a presence of UL congestion information.

24. A method of wireless communication at a first network node, comprising:
communicating with a user equipment (UE) based on dual connectivity with a second network node;
receiving a configuration for explicit congestion notification (ECN) marking at one or more of a quality of service (QoS) flow level or a data radio bearer (DRB) level; and
providing, to the second network node, ECN marking information, wherein the ECN marking information is based on the configuration.

25. The method of claim 24, wherein the dual connectivity with the second network node is associated with an extended reality (XR) application.

26. The method of claim 24, wherein the first network node is a secondary node for the dual connectivity, and the second network node is a primary node for the dual connectivity.

27. The method of claim 26, wherein the configuration for the ECN marking is comprised in an ECN marking or congestion information reporting request in one or more of:
a secondary node addition request message, or
a secondary node modification request message.

28. The method of claim 26, wherein providing the ECN marking information includes:
providing a status for the ECN marking information via a status information element (IE) in one or more of:
a secondary node addition request acknowledge message, or
a secondary node modification request acknowledge message.

29. An apparatus for wireless communication at a first network node, comprising:
means for communicating with a user equipment (UE) based on dual connectivity with a second network node;
means for receiving a configuration for explicit congestion notification (ECN) marking at one or more of a quality of service (QoS) flow level or a data radio bearer (DRB) level; and
means for providing, to the second network node, ECN marking information, wherein the ECN marking information is based on the configuration.

30. A computer-readable medium storing computer executable code at a first network node, the code when executed by at least one processor causes the at least one processor to:
communicate with a user equipment (UE) based on dual connectivity with a second network node;
receive a configuration for explicit congestion notification (ECN) marking at one or more of a quality of service (QoS) flow level or a data radio bearer (DRB) level; and
provide, to the second network node, ECN marking information, wherein the ECN marking information is based on the configuration.
